(19) United States
(12) Patent Application Publication
(10) Pub. No.: US 2025/0004168 A1
(43) Pub. Date: Jan. 2, 2025

(54) OPTICAL BENCH SYSTEM FOR PROVIDING OPTICAL PROPERTY-CONTROLLED BEAMS TO ARRAY OF TARGET LOCATIONS

(71) Applicant: Quantinuum LLC, Broomfield, CO (US)

(72) Inventors: Adam Jay OLLANIK, Boulder, CO (US); Rezlind BUSHATI, Rockville, MD (US); David MILLER, Broomfield, CO (US); David M. GAUDIOSI, Loveland, CO (US)

(21) Appl. No.: 18/753,040

(22) Filed: Jun. 25, 2024

Related U.S. Application Data
(60) Provisional application No. 63/524,122, filed on Jun. 29, 2023.

(51) Int. Cl. G02B 1/00

(52) U.S. Cl. CPC G02B 1/002

(57) ABSTRACT

An optical bench system is provided. The optical bench system includes an array of beam-customized optical components, wherein the array of beam-customized optical components comprises a plurality of beam-customized optical components; and a relay component. Each beam-customized optical component of the plurality of beam-customized optical components is configured to control optical properties of a respective optical beam of a plurality of optical beams to provide a plurality of property-controlled optical beams. The relay component is configured to relay the plurality of property-controlled optical beams to respective target locations of an array of target locations.

### CROSS-REFERENCE TO RELATED APPLICATIONS

This application claims priority to U.S. Application No. 63/524,122, field Jun. 29, 2023, the content of which is incorporated herein by reference in its entirety.

### TECHNICAL FIELD

Various embodiments relate to an optical bench system and/or beam plate configured to provide optical property-controlled beams to an array of target locations. An example embodiment relates to an optical bench system and/or beam plate configured to provide optical beams to target locations of a quantum object confinement apparatus.

### BACKGROUND

When using an ion trap to perform quantum computing, gates and other functions of the quantum computer are performed by applying laser beams to ions contained within the ion trap. Delivering these laser beams to a large scale quantum computer is a significant challenge due at least in part to the significant amount of space required by conventional beam plates. Through applied effort, ingenuity, and innovation many deficiencies of prior laser beam delivery systems have been solved by developing solutions that are structured in accordance with the embodiments of the present invention, many examples of which are described in detail herein.

### BRIEF SUMMARY OF EXAMPLE EMBODIMENTS

Example embodiments provide optical bench systems and/or beam plates, systems including optical bench systems and/or beam plates, and/or the like. For example, an example embodiment provides a quantum charge-coupled device (QCCD)-based quantum computer including an optical bench system and/or beam plate. In various embodiments, the optical bench system and/or beam plate includes an array of beam-customized optical components and a relay component. The array of beam-customized optical components comprises a plurality of beam-customized optical components and each beam-customized optical component is configured to control optical properties of a respective optical beam. The array of beam-customized optical components receives a plurality of optical beams and provides an array of property-controlled optical beams where the optical properties of each optical beam are controlled and/or conditioned independently by a respective beam-customized optical component. The relay component is configured to relay the plurality of property-controlled optical beams to respective target locations of an array of target locations. For example, the relay component is configured to provide a respective property-controlled optical beam to a respective target location at an appropriate incident angle for the respective target location.

According to an aspect of the present disclosure, an optical bench system. In an example embodiment, the optical bench system includes an array of beam-customized optical components, and a relay component. The array of beam-customized optical components comprises a plurality of beam-customized optical components. Each beam-customized optical component of the plurality of beam-customized optical components is configured to control optical properties of a respective optical beam of a plurality of optical beams to provide a plurality of property-controlled optical beams. The relay component is configured to relay the plurality of property-controlled optical beams to respective target locations of an array of target locations.

In an example embodiment, each beam-customized optical component comprises a respective metasurface.

In an example embodiment, each beam-customized optical component comprises at least one of a waveplate or a lens.

In an example embodiment, the respective incident location is one of an object location or a target apparatus-integrated optical element.

In an example embodiment, the optical bench system further includes a beam source array comprising a plurality of beam sources, wherein a respective beam source of the plurality of beam sources is configured to provide the respective optical beam to a respective beam-customized optical component.

In an example embodiment, the beam source array is one of a one-dimensional array of beam sources or a two-dimensional array of beam sources.

In an example embodiment, the array of target locations is one of a one-dimensional array of target locations or two-dimensional array of target locations.

In an example embodiment, the respective beam-customized optical component is configured to correct any directing errors introduced by a respective beam source of the beam source array.

In an example embodiment, the optical properties of the respective optical beam include a polarization of the respective optical beam.

In an example embodiment, the optical properties of the respective optical beam include a wavelength, focusing, beam waist, phase, direction of propagation, beam profile, or intensity of the respective optical beam.

In an example embodiment, a respective beam-customized optical component comprises an upstream surface and a downstream surface, the respective beam-customized optical component is configured to receive the respective optical beam incident on the upstream surface, control the optical properties of the optical beam, and provide a property-controlled optical beam via the downstream surface.

In an example embodiment, the respective optical beam incident on the upstream surface defines an incident beam axis, the property-controlled optical beam provided via the downstream surface defines a first order beam axis, and the incident beam axis is not parallel to the first order beam axis.

In an example embodiment, a difference in a direction defined by the incident beam axis and a direction defined by the first order beam axis is used to spatially filter the property-controlled optical beam provided to a respective target location of the array of target locations.

According to another aspect, a quantum computing system is provided. In an example embodiment, the quantum computing system includes one or more manipulation sources; an optical bench system; and a quantum object confinement apparatus defining an array of target locations. The optical bench system includes a beam source array comprising a plurality of beam sources, an array of beam-customized optical components, wherein the array of beam-customized optical components comprises a plurality of beam-customized optical components; and a relay component. A respective beam source of the plurality of beam sources is configured to provide a respective optical beam to a respective beam-customized optical component of the array of beam-customized optical components. The respective beam-customized optical component is configured to control optical properties of the respective optical beam to provide a respective property-controlled optical beam. The relay component is configured to relay the respective property-controlled optical beam to a respective target location of the array of target locations. A respective manipulation source of the one or more manipulation sources is configured to provide the respective optical beam to the respective beam source.

In an example embodiment, the respective beam-customized optical component comprises a respective metasurface.

In an example embodiment, the respective beam-customized optical component comprises at least one of a waveplate or a lens.

In an example embodiment, the respective incident location is one of an object location or a target apparatus-integrated optical element.

In an example embodiment, the respective beam-customized optical component is configured to correct any directing errors introduced by a respective beam source of the beam source array.

In an example embodiment, the optical properties of the respective optical beam include a polarization, wavelength, focusing, beam waist, phase, direction of propagation, beam profile, or intensity of the respective optical beam.

In an example embodiment, a respective beam-customized optical component comprises an upstream surface and a downstream surface, the respective beam-customized optical component is configured to receive the respective optical beam incident on the upstream surface, control the optical properties of the optical beam, and provide a property-controlled optical beam via the downstream surface, the respective optical beam incident on the upstream surface defines an incident beam axis, the property-controlled optical beam provided via the downstream surface defines a first order beam axis, the incident beam axis is not parallel to the first order beam axis, and a difference in a direction defined by the incident beam axis and a direction defined by the first order beam axis is used to spatially filter the property-controlled optical beam provided to the respective target location of the array of target locations.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of an example optical bench system, according to an example embodiment.

FIGS. 2A, 2B, and 2C each provide a schematic cross-sectional diagram of a respective example array of beam-customized optical components, according to example embodiments.

FIG. 3 is a schematic diagram illustrating an example optical bench system, according to an example embodiment.

FIGS. 4A and 4B provide a top view and a side view, respectively, of an example optical bench system, according to an example embodiment.

FIGS. 5A and 5B provide a top view and a side view, respectively, of an example optical bench system, according to another example embodiment.

FIG. 6 is a schematic diagram illustrating an example optical bench system, according to an example embodiment.

FIGS. 7A and 7B provide a top view and a side view, respectively, of an example optical bench system, according to an example embodiment.

FIG. 8 is a schematic diagram of an example optical bench system having a two-dimensional array of beam sources, according to an example embodiment.

FIG. 9 is a schematic diagram of an example quantum computing system that includes an optical bench system, according to an example embodiment.

FIG. 10 provides a schematic diagram of an example controller of a quantum computer configured to control operation of various components of a quantum processor, according to various embodiments.

FIG. 11 provides a schematic diagram of an example computing entity of a quantum computing system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Example embodiments provide optical bench systems and/or beam plates, systems including optical bench systems and/or beam plates, and/or the like. For example, an example embodiment provides a quantum charge-coupled device (QCCD)-based quantum computer including an optical bench system and/or beam plate. In various embodiments, the optical bench system and/or beam plate includes an array of beam-customized optical components and a relay component. The array of beam-customized optical components comprises a plurality of beam-customized optical components and each beam-customized optical component is configured to control optical properties of a respective optical beam. The array of beam-customized optical components receives a plurality of optical beams and provides an array of property-controlled optical beams where the optical properties of each optical beam are controlled and/or conditioned independently by a respective beam-customized optical component. The relay component is configured to relay the plurality of property-controlled optical beams to respective target locations of an array of target locations. For example, the relay component is configured to provide a respective property-controlled optical beam to a respective target location at an appropriate incident angle for the respective target location.

In various embodiments, the array of beam-customized optical components is configured to receive an array of optical beams. For example, a beam source array may provide an array of optical beams such that the respective optical beams of the array of optical beams are incident on an upstream surface of a respective beam-customized optical component. In various embodiments, each beam-customized optical component of the array of beam-customized optical components comprises one or more optical elements such as metasurfaces, waveplates, diffractive optical elements (e.g., diffractive lenses, gratings) refractive optical elements (e.g., refractive lenses), and/or the like. The one or more optical elements of a beam-customized optical component are configured to control and/or condition one or more optical properties of an optical beam that is provided to the relay component, for example, via the downstream surface of the beam-customized optical component. For example, the one or more optical elements of the beam-customized optical component may be configured to control the polarization, wavelength, focusing, beam waist, phase, direction of propagation, beam profile, intensity, and/or other optical property of the property-controlled optical beam provided to the relay component, for example, via the downstream surface of the beam-customized optical component.

In various embodiments, the relay component is configured to relay the array of property-controlled optical beams that are conditioned by the array of beam-customized optical components (e.g., that optical beams that have had their optical properties controlled by the array of beam-customized optical components) to an array of target locations. For example, the relay component comprises one or more lenses and/or relay optical elements configured to optically manipulate the beam paths of the array of property-controlled optical beams to extend across the distance between the array of beam-customized optical components and the array of target locations. In various embodiments, the relay component is configured to provide respective property-controlled optical beams to respective target locations at a respective appropriate incident angles for the respective target locations. In various embodiments, the one or more lenses and/or relay optical elements of the relay component comprise diffractive optical elements and/or metasurfaces.

In various embodiments, the array of target locations are disposed on a target apparatus. In various embodiments, the target apparatus is a quantum object confinement apparatus. For example, in an example embodiment, the target apparatus is an ion trap such as a surface ion trap or a Paul trap. In various embodiments, the array of target locations includes object locations and/or target apparatus-integrated optical elements. In various embodiments, each target location is configured for a property-controlled optical beam to be incident thereat at a respective appropriate incident angle.

For example, an object location is a location defined at least in part by the quantum object confinement apparatus such that the quantum object confinement apparatus is configured to confine one or more quantum objects at the object location. An (property-controlled) optical beam may be incident on the one or more quantum objects at the object location to cause controlled evolution of a quantum state of the quantum object, to probe or detect a quantum state of the quantum object, to perform laser cooling on the quantum object, to ionize the quantum object, and/or the like. In various embodiments, a quantum object is a neutral or ionized atom; neutral, ionized, or multipole molecule; a quantum particle; crystals or groups of atoms, molecules, and/or quantum particles; and/or other object confinable by the quantum object confinement apparatus and for which the quantum state thereof may be manipulated.

In various embodiments, the target apparatus may include one or more target apparatus-integrated optical elements. For example, the target apparatus-integrated optical elements may include metasurfaces, waveguide inputs, diffractive optics, resonant cavities, laser gain media, and/or the like configured to cause respective (property-controlled) optical beams to be incident at respective object locations. Various examples of target-apparatus-integrated optical elements are described by U.S. application Ser. No. 17/653,979, filed Mar. 9, 2022, U.S. application Ser. No. 18/190,496, filed Mar. 27, 2023, U.S. application Ser. No. 18/299,785, filed Apr. 12, 2023, and U.S. Application No. 63/378,124, filed Oct. 3, 2022, the contents of which are incorporated herein by reference in their entireties.

Conventional beam plates and/or machined optical bread boards that house optical elements configured to control optical properties of laser beams provided to target locations tend to be multiple square feet in area. As target apparatuses increase in size and the number of optical beams to be provided to the target locations of the target apparatus increases, the physical size required for such conventional beam plates and/or machined optical bread boards becomes very large. The size of such conventional beam plates and/or machined optical bread boards, in addition to taking up a significant amount of physical space, may introduce errors and/or noise into functions performed by systems including such conventional beam plates and/or machined optical bread boards. For example, a small misalignment of an optical element may result in optical properties of a resultant optical beam provided to a target location being different from expected, resulting in the introduction of errors and/or noise in the function being performed via the use of the resultant optical beam. Therefore, technical problems exist regarding how to provide an array of optical beams to respective target locations of a target apparatus.

Various embodiments provide technical solutions to these technical problems. In various embodiments, an optical bench system is provided that includes a plurality of beam-customized optical elements that are formed on a beam plate substrate or a series of beam plate substrates. In various embodiments, the plurality of beam-customized optical elements include metasurfaces, An example optical bench system further comprises a relay component configured to relay an array of (property-controlled) optical beams to the array of target locations. In various embodiments, the beam plate substrates define a surface area that is at most five inches by five inches. Thus, rather than requiring multiple square feet of surface area as do conventional beam plates, a beam plate substrate of an example optical bench system has a surface area of less than one-fifth of a square foot, in various embodiments. Additionally, the forming of the beam-customized optical elements on the beam plate substrate(s) decreases the complexity of aligning individual optical elements of the array of beam paths. Thus, various embodiments provide technical improvements to the fields of beam delivery systems, systems that include beam delivery systems, QCCD-based quantum computing, and/or the like.

### Example Optical Bench System

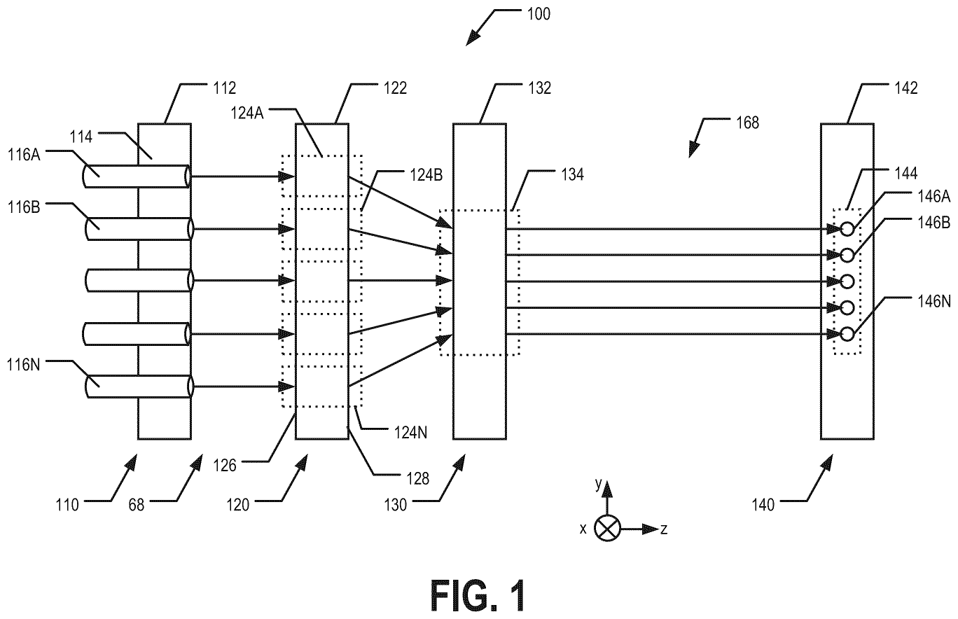

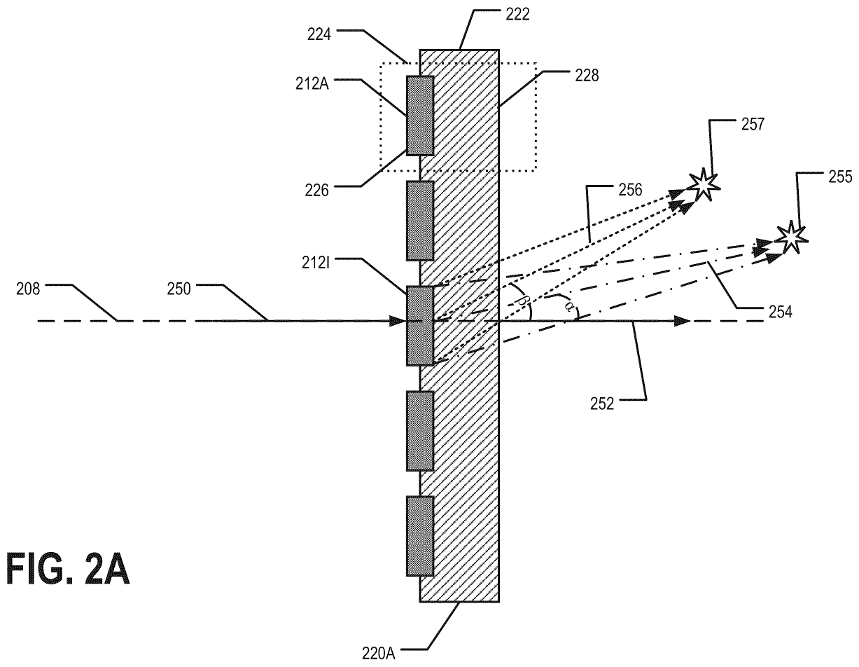

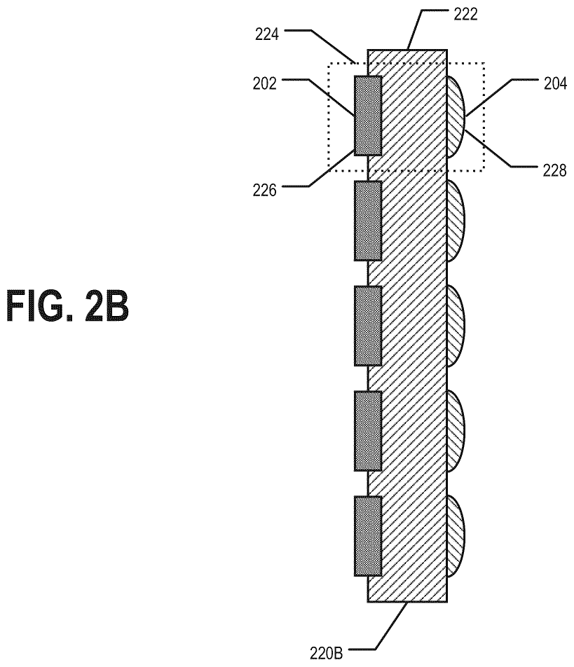

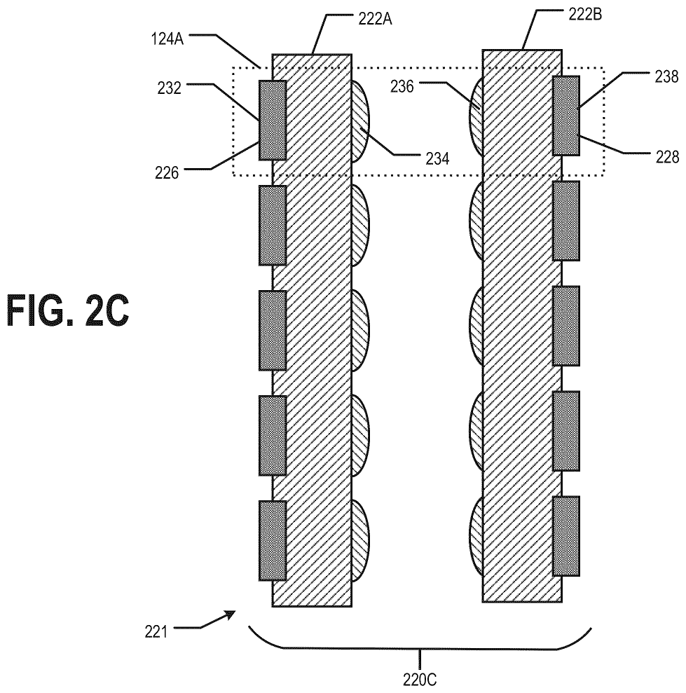

Various embodiments provide an optical bench system. FIG. 1 provides a schematic diagram of an example optical bench system 100. In various embodiments, an optical bench system 100 comprises an array of beam-customized optical components 120 and a relay component 130. In various embodiments, the array of beam-customized optical components 120 comprises a plurality of beam-customized optical components 124 (e.g., 124A, 124B, . . . , 124N) formed and/or disposed on a beam plate substrate 122 or a series 221 of beam plate substrates 222 (see FIG. 2C). In various embodiments, a beam plate substrate 122 is formed of glass or another material that is transparent to light characterized by wavelengths corresponding to the array of optical beams.

While FIG. 1 illustrates the array of beam-customized optical components 120 comprising five beam-customized optical components 124, it should be noted that in various embodiments, the array of beam-customized optical components 120 may comprise fewer than five or more than five (e.g., up to a million or more, in an example embodiment) beam-customized optical components 124, in various embodiments.

Each of the beam-customized optical components 124 comprises one or more optical elements. For example, a respective beam-customized optical component 124 includes a single optical element, in an example embodiment, and as assembly, series, or sequence of optical elements, in an example embodiment. In various embodiments, the one or more optical elements include one or more metasurfaces. In various embodiments, the one or more optical elements include one or more waveplates, lenses, aspheric collimator, and/or the like. In various embodiments, a respective beam-customized optical component 124 is configured to control and/or condition optical properties of a respective optical beam (e.g., laser beam, series of laser pulses, microwave beam, and/or the like). For example, the respective beam-customized optical component is configured to control and/or condition the polarization, wavelength, focusing, beam waist, wavelength, phase, direction of propagation, beam profile, intensity, and/or other optical property of the respective optical beam.

In various embodiments, a respective beam-customized optical component 124 is configured to correct any directing errors (e.g., errors in pointing direction, alignment, and/or where and/or how a respective optical beam source provides the respective optical beam to the respective beam-customized optical component 124). For example, the respective beam-customized optical component 124 is configured to cause a respective optical beam to exit the downstream surface 128 of the respective beam-customized optical component 124 in a particular manner, even when the optical beam incident on the upstream surface 126 of the respective beam-customized optical component 124 is not centered on the optical axis of the respective beam-customized optical component 124 and/or not perfectly aligned with the respective beam-customized optical component 124.

In various embodiments, a respective beam-customized optical component 124 is configured to control the angle of the optical path of the respective (property-controlled) optical beam exiting the downstream surface 128 of the respective beam-customized optical component 124. In various embodiments, the array of beam-customized optical elements 120 is configured to control the spacing of a plurality of property-controlled optical beams provided to the relay component 130. For example, the array of beam-customized optical elements 120 is configured to cause the respective property-controlled optical beams to be incident on respective target locations 146 (e.g., 146A, 146B, . . . , 146N) of an array of target locations 144 as a result of the respective optical beams be relayed to the target apparatus 140 via the relay component 130.

In various embodiments, the relay component 130 comprises one or more relay optical elements 134. For example, the relay component 130 comprises one or more relay optical elements 134 formed and/or disposed on one or more relay substrates 132, in various embodiments. For example, the one or more relay optical elements 134 may include one or more lenses and/or lens assemblies, one or more metasurfaces, and/or a combination thereof. In various embodiments, each of the one or more relay optical elements 134 may be configured to interact with at least one optical beam, a plurality of the optical beams, and/or all of the optical beams. For example, in various embodiments where the distance between the relay component 130 and the target apparatus 140 is larger than the spacing between respective target locations 146 of the array of target locations 144, the optical paths of the plurality of optical beams overlap in at least a portion of the space between the downstream surface of the array of beam-customized optical elements 120 and the target apparatus 140. For example, the optical paths of the plurality of optical beams may overlap at least along the respective portions of the optical paths that pass through the relay component 130. For example, in one example embodiment, the spacing between the respective target locations 146 is on the order of 1 millimeter and the distance between the relay component 130 and the target apparatus 140 is on the order of 200 millimeters and the optical paths of the plurality of optical beams overlap in at least a portion of the space between the downstream surface of the array of beam-customized optical elements 120 and the target apparatus 140. In various other embodiments, the spacing between the relay component 130 and the target apparatus 140 may be on a kilometer scale, meters scale (e.g., 100s of meters, 10s of meters, one or a few meters), centimeter scale, millimeters scale, micron scale (e.g., 100s of microns, 10s of microns, one or a few microns), nanometer scale (e.g., 100s of nanometers, 10s of nanometers, one or a few nanometers), as appropriate for the application.

In various embodiments, a target apparatus 140 defines an array of target locations 144. For example, a target apparatus 140 may formed on and/or comprise one or more apparatus substrates 142 and one or more target locations 146 may be defined on the one or more apparatus substrates 142 and/or in a space near the surface of the one or more apparatus substrates 142. For example, the target locations 146 include object locations and/or target apparatus-integrated optical elements. In various embodiments, a respective target location 146 is configured for a property-controlled optical beam to be incident thereat at a respective appropriate incident angle and the relay component 130 is configured to provide the respective property-controlled optical beam to the respective target location 146 at the respective appropriate incident angle.

For example, an object location is a location defined at least in part by the quantum object confinement apparatus such that the quantum object confinement apparatus is configured to confine one or more quantum objects at the object location. An optical beam may be incident on the one or more quantum objects at the object location to cause controlled evolution of a quantum state of the quantum object, to probe or detect a quantum state of the quantum object, to perform laser cooling on the quantum object, to ionize the quantum object, and/or the like. In various embodiments, a quantum object is a neutral or ionized atom; neutral, ionized, or multipole molecule; a quantum particle; crystals or groups of atoms, molecules, and/or quantum particles; and/or other object confinable by the quantum object confinement apparatus and for which the quantum state thereof may be manipulated. For example, in an example embodiment, the target apparatus is an ion trap such as a surface ion trap or a Paul trap, the quantum object is an ion, and the object location is a location at which the ion trap is configured to confine one or more ions.

In various embodiments, the target apparatus may include one or more target apparatus-integrated optical elements. For example, the target apparatus-integrated optical elements may include metasurfaces, waveguide inputs, diffractive optics, resonant cavities, laser gain media, and/or the like configured to cause respective optical beams to be incident at respective object locations. For example, the one or more target apparatus-integrated optical elements may be formed and/or disposed on the one or more apparatus substrates 142. For example, continuing the example from above the ion trap, the one or more target apparatus-integrated optical elements include optical elements formed and/or disposed on a surface of and/or in a substrate hosting the ion trap and/or a bridge chip, beam delivery chip, cloud chip, and/or photonic platform secured in relation to the substrate hosting the ion trap.

In various embodiments, an array of beam sources 110 is configured to provide a plurality and/or array of optical beams 68 to the array of beam-customized optical components 120. For example, in the illustrated embodiment of FIG. 1, the array of beam sources 110 includes a v-groove array 114 formed on a beam source substrate 112 and having a plurality of optical fibers 116 (e.g., 116A, 116B, . . . , 116N) secured into respective v-grooves of the v-groove array 114. Each of the beam sources (e.g., optical fiber 116, a waveguide, or free space/bulk optics) provides a respective optical beam such that the respective optical beam is incident on the upstream surface of a respective beam-customized optical component 124. For example, a first optical fiber 116A provides a first optical beam of the plurality of optical beams 68 that is incident on the upstream surface 126 of a first beam-customized optical component 124A. the first beam-customized optical component 124A is configured to correct for any directing errors, such as errors in alignment of the first optical fiber 116A (e.g., due to alignment errors in the optical fiber 116 position in the respective v-groove of the v-groove array 114, alignment of the optical fiber core of the optical fiber, and/or the like). In an example embodiment, the beam source substrate 112 is coupled and/or secured to a beam plate substrate 122.

FIGS. 2A, 2B, and 2C illustrate some example embodiments of an array of beam-customized optical components 220A, 220B, 220C. Starting with FIG. 2A, the example embodiment of the array of beam-customized optical components 220A comprises a plurality of beam-customized optical components 224 formed on a beam plate substrate 222. The array of beam-customized optical components 220A includes one optical element 212 (e.g., 212A, 212I) in each beam-customized optical component 224. For example, a respective beam-customized optical component 224 includes a single optical element 212. In various embodiments, the optical element 212 is a metasurface. In various embodiments, the optical element 212 is a metasurface configured to act as a waveplate and/or to control or condition the polarization of an optical beam incident on the upstream surface 226 of the beam-customized optical component 224 and provided via the downstream surface 228 of the beam-customized optical component 224. In various embodiments, the optical element 212 is configured to control and/or condition the direction of propagation, focusing, beam waist, wavelength, phase, beam profile, and/or other optical property such that, after the optical beam provided via the via the downstream surface 228 of the beam-customized optical component 224 is relayed to a respective target location 146 via the relay component 130, the optical beam has desired optical properties when the optical beam is incident on the respective target location 146.

FIG. 2B illustrates an example array of beam-customized optical components 220B that comprises a plurality of beam-customized optical components 224 formed on a beam plate substrate 222. The array of beam-customized optical components 220B includes a respective pair of optical elements in each beam-customized optical component 224. For example, a respective beam-customized optical component 224 includes a first optical element 202 and a second optical element 204. In an example embodiment, the first optical element 202 is a waveplate and the second optical element 204 is a lens. For example, in an example embodiment, the second optical element 204 is an aspheric collimator. In an example embodiment, one or both of the first optical element 202 or the second optical element 204 are metasurfaces (e.g., a metasurface waveplate and a metasurface lens, in an example embodiment). In various embodiments, one or both of the first optical element 202 or the second optical element 204 are diffractive optical components. In various embodiments, the first optical clement 202 is a metasurface configured to act as a waveplate and/or to control or condition the polarization (and possibly one or more other optical properties) of an optical beam incident on the upstream surface 226 of the beam-customized optical component 224 and provided via the downstream surface 228 of the beam-customized optical component 224. In various embodiments, the second optical element 204 is configured to control and/or condition the direction of propagation, focusing, beam waist, wavelength, phase, beam profile, and/or other optical property such that, after the optical beam provided via the via the downstream surface 228 of the beam-customized optical component 224 is relayed to a respective target location 146 via the relay component 130, the optical beam has desired optical properties when the optical beam is incident on the respective target location 146.

FIG. 2C illustrates an example array of beam-customized optical components 220C comprising a plurality of beam-customized optical components 224 formed on a series 221 or sequence of beam plate substrates 222A, 222B. The array of beam-customized optical components 220C includes a respective plurality of optical elements in each beam-customized optical component 224. For example, a respective beam-customized optical component 224 includes a first optical element 232, a second optical element 234, a third optical element 236 and a fourth optical element 238. In an example embodiment, the first optical element 232 and the fourth optical element 238 are waveplates and the second optical element 234 and the third optical clement 236 are lenses. In various embodiments, one or more of the first, second, third, or fourth optical elements 232, 234, 236, 238 are metasurfaces (e.g., metasurface waveplates or metasurface lenses). In various embodiments, one or more of the first, second, third, or fourth optical elements 232, 234, 236, 238 are diffractive optical elements. In an example embodiment, one of the first, second, third, or fourth optical elements 232, 234, 236, 238 is an aspheric collimator.

In various embodiments, the first optical element 232 and the fourth optical element 238 are configured to act as waveplates and/or to control or condition the polarization (and possibly one or more other optical properties) of an optical beam incident on the upstream surface 226 of the beam-customized optical component 224 and provided via the downstream surface 228 of the beam-customized optical component 224. In various embodiments, the second optical element 234 and third optical element 236 are configured to control and/or condition the direction of propagation, focusing, beam waist, wavelength, phase, beam profile, and/or other optical property such that, after the optical beam provided via the via the downstream surface 228 of the beam-customized optical component 224 is relayed to a respective target location 146 via the relay component 130, the optical beam has desired optical properties when the optical beam is incident on the respective target location 146.

In various embodiments, at least a portion of the beam path of a respective optical beam is not parallel to the optical axis of a respective beam-customized optical component and/or optical element thereof. For example, the beam axis of the optical beam that is incident on the upstream surface 226 of a beam-customized optical component 224 is different from (e.g., not parallel to and/or forms a non-zero angle with) the beam axis of the optical beam that is provided via the downstream surface 228 of the beam-customized optical component 224. For example, FIG. 2A illustrates an incident beam axis 250 of an optical beam incident on optical element 212I of a respective beam-customized optical component 224. The incident beam axis 250 is parallel to an optical axis 208 of the optical element 212I and/or the respective beam-customized optical component. The zero order and/or unaffected beam axis 252 illustrates the beam axis of an optical beam that passed through the respective beam-customized optical component 224 without being changed and/or affected by the optical element 212I.

The first order beam axis 254 illustrates the beam axis of a first order optical beam 255 that was modified in accordance with a first order effect of the optical element 212I. For example, the first order beam axis 254 is the beam axis of a first order optical beam 255. The first order beam axis 254 forms a first order angle a with the optical axis 208 of the respective beam-customized optical component 224. The first order angle a is non-zero. For example, the first order angle a is between five and eighty degrees, in an example embodiment. In various embodiments, the first order optical beam 255 has the desired optical properties for being incident on the respective target location 146.

The second order beam axis 256 illustrates the beam axis of a second order optical beam 257 that was modified in accordance with a second order effect of the optical element 212I. For example, second order beam axis 256 is the beam axis of a second order optical beam 257. The second order beam axis 256 forms a second order angle β with the optical axis 208 of the respective beam-customized optical component 224. The second order angle β is non-zero. For example, in various embodiments, the second order angle B is different from the first order angle a. In an example embodiment, the second order angle β is larger than the first order angle a (e.g., twice the first order angle a, in an example embodiment). Various other non-zero order beams form respective order angles with the optical axis 208 that are non-zero.

In various embodiments, the differences in the respective angles between the optical axis 208 of the respective beam-customized optical component 224 and a respective one of the zero order and/or unaffected beam axis 252, the first order beam axis 254, and the second order beam axis 256 (and subsequent higher order beam axes) enables spatial filtering of the optical beam provided to the respective target location of the target apparatus. For example, spatial filtering may be used such that the first order optical beam 255 is relayed to the respective target location via the relay component and the zero order and second order (and any higher order) optical beams propagating along the zero order beam axis or the second order beam axis 252, 256, respectively, are not relayed to the respective target location via the relay component.

In various embodiments, the optical bench system 100 is compact. For example, each beam plate substrate 222 defines a surface area that is at most five inches by five inches, in various embodiments. Thus, the optical bench system 100 is compact compared to conventional optical bench systems that tend to use beam plates that are define surface areas of multiple square feet. The configuration of the optical bench system 100 into the array of beam-customized optical components 120 and the relay component 130 enable the compact size of the optical bench system 100. For example, the use of respective metasurface optical elements in the respective beam-customized optical components enables the space-efficient controlling and/or conditioning of optical properties of the array of optical beams and provision of the array of optical beams to the respective target locations.

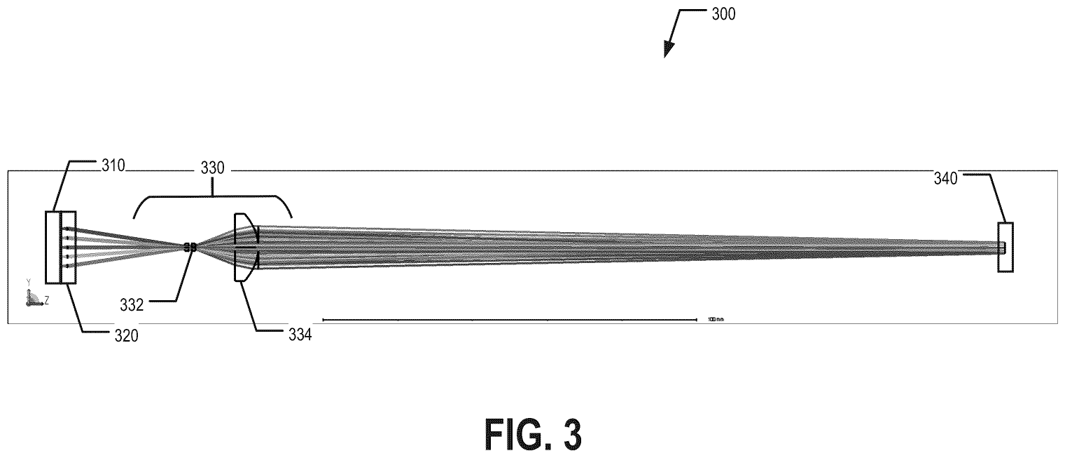

FIGS. 3-8 illustrate some example optical bench systems. As should be understood, these examples are provided to be illustrative rather than limiting.

FIG. 3 provides a schematic diagram of an example embodiment of optical bench system 300. The optical bench system 300 includes an array of beam sources 310, an array of beam-customized optical components 320, a relay component 330 configured to relay a plurality of (property-controlled) optical beams to respective target locations defined at least in part by a target apparatus 340. In the illustrated embodiment, the relay component comprises an assembly of negative lenses 332. For example, the assembly of negative lenses 332 includes a pair of divergent, negative, concave, or dispersive lenses, in an example embodiment. The relay component 330 further includes a focusing element 334 configured to focus each of the respective optical beams on a respective target location defined at least in part by the target apparatus 340.

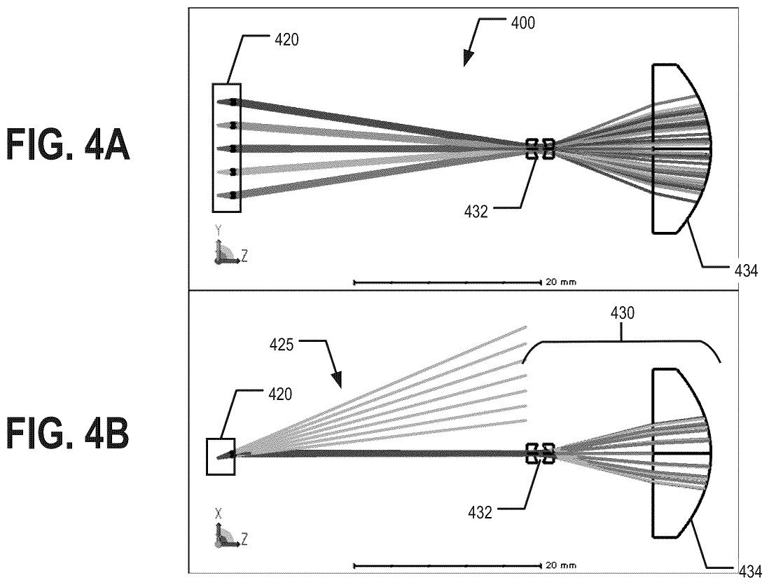

FIG. 4A is a top view of an example optical bench system 400 and FIG. 4B is a side view of the example optical bench system 400. In the illustrated embodiment, the array of beam-customized optical components 420 is similar to the array of beam-customized optical components 220A illustrated in FIG. 2A. For example, each beam-customized optical component consists of a single metasurface optical element. The relay component 430 is similar to the relay component 330 in that it comprises a pair of negative lenses 432 and a focusing clement 434. As shown in FIG. 4B, the respective optical beams provided by the downstream surface of the respective beam-customized optical components are spatially filtered so that the selected order (e.g., first order) optical beams are incident on the pair of negative lenses 432 and the non-selected order optical beams 425 are not. For example, the non-selected order optical beams 425 (e.g., including zero order optical beam, second order optical beam and/or higher order optical beams when the first order optical beam is the selected order optical beam) are deflected by the respective beam-customized optical component such that the non-selected order optical beams 425 are not relayed to the respective target locations.

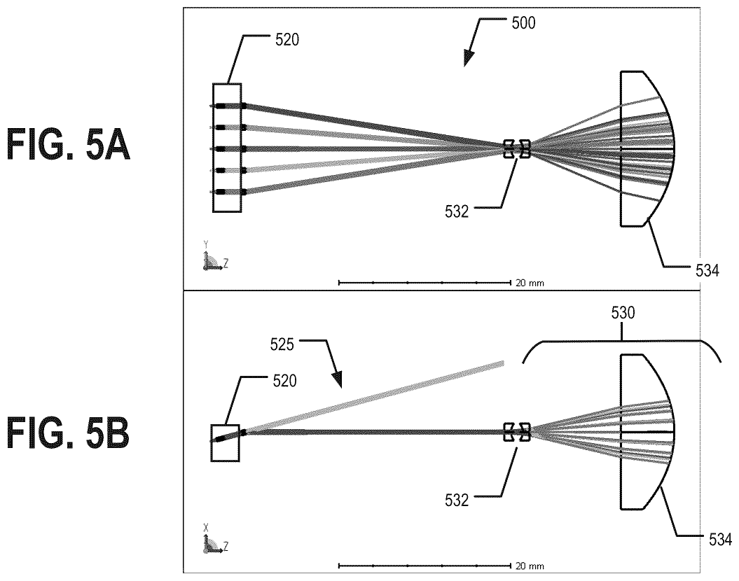

FIG. 5A is a top view of an example optical bench system 500 and FIG. 5B is a side view of the example optical bench system 500. In the illustrated embodiment, the array of beam-customized optical components 520 is similar to the array of beam-customized optical components 220B illustrated in FIG. 2B. For example, each beam-customized optical component consists of a metasurface (waveplate) optical element and an aspheric collimator. The relay component 530 is similar to the relay component 330 in that it comprises a pair of negative lenses 532 and a focusing clement 534.

As shown in FIG. 5B, the respective optical beams provided by the downstream surface of the respective beam-customized optical components are spatially filtered so that the selected order (e.g., first order) optical beams are incident on the pair of negative lenses 532 and the non-selected order optical beams 525 are not. For example, the non-selected order optical beams 525 (e.g., including zero order optical beam, second order optical beam and/or higher order optical beams when the selected order optical beam is the first order optical beam) are deflected by the respective beam-customized optical component such that the non-selected order optical beams 525 are not relayed to the respective target locations.

In FIG. 4B, the non-selected order optical beams 425 form a fan or sequence of undesired optical beams. In FIG. 5B, the non-selected order optical beams 525 form a single undesired optical beam as a result of the inclusion of the respective aspheric collimators in the respective beam-customized optical components of the array of beam-customized optical components 520.

In various embodiments, one or more of the non-selected order optical beams 425, 525 are provided to a photodiode, power meter, or other optical device that may be used to monitor alignment, power output, power fluctuations, phase fluctuations, wavelength fluctuations, noise, and/or the like of the optical beams and/or the optical bench system 400, 500.

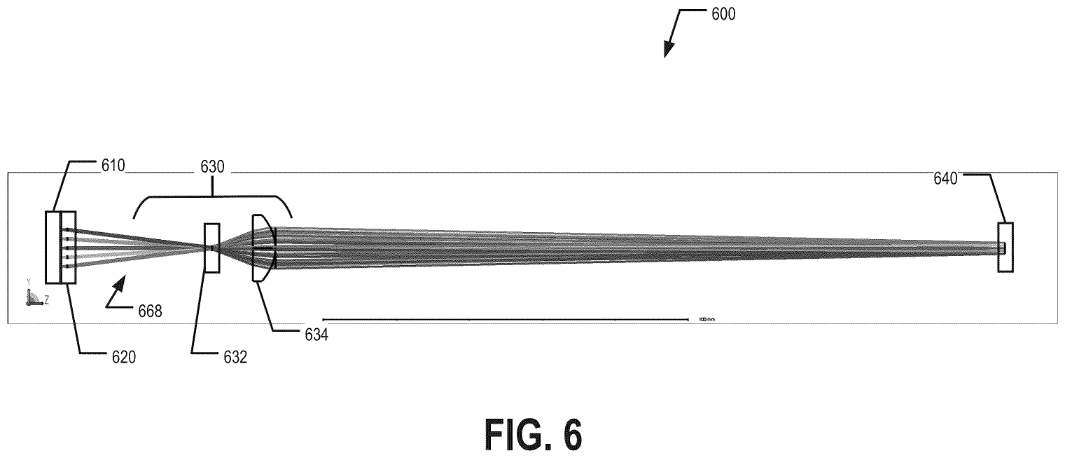

FIG. 6 provides a schematic diagram of another example embodiment of optical bench system 600. The optical bench system 600 includes an array of beam sources 610, an array of beam-customized optical components 620, a relay component 630 configured to relay a plurality of optical beams to respective target locations defined at least in part by a target apparatus 640. In the illustrated embodiment, the relay component 630 comprises a global metasurface element 632 and a focusing element 634. The global metasurface element 632 is referred to as global because each of the optical beams of the array of optical beams 668 interacts with and/or is conditioned by the global metasurface element 642. The focusing element 634 is configured to focus each of the respective optical beams on a respective target location defined at least in part by the target apparatus 640.

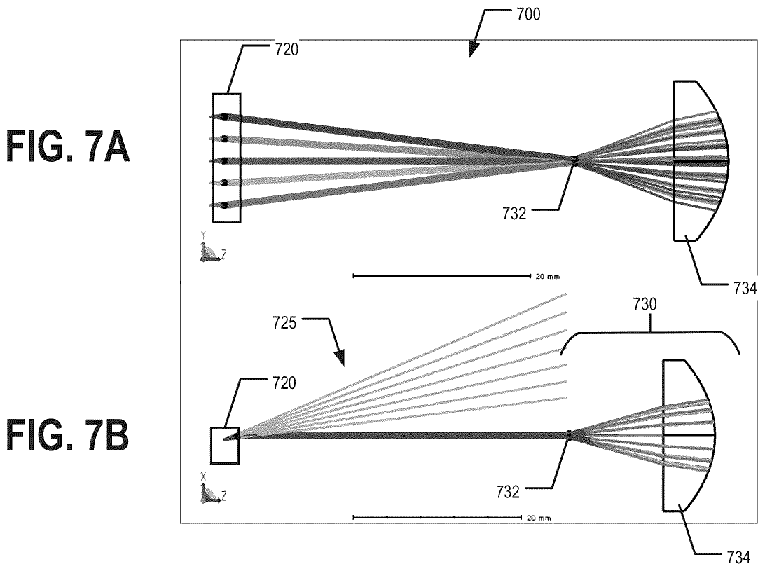

FIG. 7A is a top view of an example optical bench system 700 and FIG. 7B is a side view of the example optical bench system 700. In the illustrated embodiment, the array of beam-customized optical components 720 is similar to the array of beam-customized optical components 220A illustrated in FIG. 2A. For example, each beam-customized optical component consists of a single metasurface optical element. The relay component 730 is similar to the relay component 630 in that it comprises a global metasurface element 732 and a focusing clement 734. As shown in FIG. 7B, the respective optical beams provided by the downstream surface of the respective beam-customized optical components are spatially filtered so that the selected order (e.g., first order) optical beams are incident on the global metasurface element 732 and the non-selected order optical beams 725 are not. For example, the non-selected order optical beams 725 (e.g., including the zero order optical beam, second order optical beam, and/or higher order optical beams when the selected order optical beam is a first order optical beam) are deflected by the respective beam-customized optical component such that the non-selected order optical beams 725 are not relayed to the respective target locations.

In various embodiments, one or more of the non-selected order optical beams 725 are provided to a photodiode, power meter, or other optical device that may be used to monitor alignment, power output, power fluctuations, phase fluctuations, wavelength fluctuations, noise, and/or the like of the optical beams and/or the optical bench system 700.

In various embodiments, the array of beam sources 110 is a one-dimensional array, two-dimensional array, or three-dimensional array. In various embodiments, the array of target locations 144 is a one-dimensional array, two-dimensional array, or three-dimensional array. In various embodiments, the dimensionality of the array of beam sources 110 may or may not be the same as the dimensionality of the array of target locations 144.

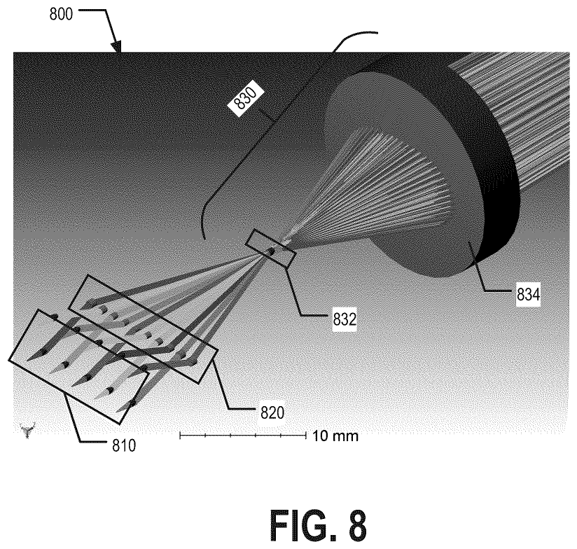

FIG. 8 illustrates an example optical bench system 800 comprising a two-dimensional array of beam sources 810. The array of beam-customized optical components 820 may be similar to the array of beam-customized optical components 220A, 220B, 220C, and/or may include beam-customized optical components that include different configurations of optical elements. In various embodiments, the beam-customized optical components of the array of beam-customized optical components 820 are arranged in a one-dimensional array or a two-dimensional array. The relay component 830 includes a global metasurface element 832 and a relay optical element 834. In various embodiments, the relay component 830 may include a pair of negative lenses, similar to the negative lenses 332. In various embodiments, the relay component 830 may include a different configuration of one or more optical elements configured to relay the array of optical beams provided via the downstream surface of the array of beam-customized optical components 820 to respective target locations of the target apparatus.

As illustrated in FIG. 1, the array of beam-customized optical components 120 is disposed between the array of beam sources 110 and the relay component 130. However, in an example embodiment, the array of beam-customized optical components 120 is disposed between the relay component and the target apparatus. For example, the relay component 130 may be disposed between the array of beam sources 110 and the array of beam-customized optical components 120.

### Example Quantum Computing System Comprising an Optical Bench System

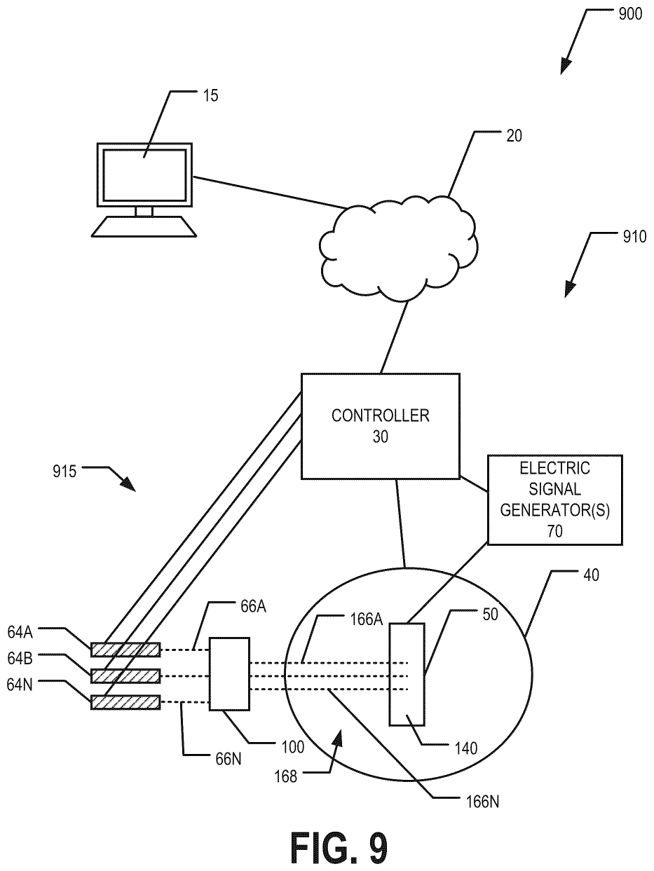

In various embodiments, an optical bench system 100, 300, 400, 500, 600, 700, 800 is part of a system. For example, the optical bench system 100, 300, 400, 500, 600, 700, 800 may be part of a system or assembly that includes one or more beam sources configured to generate and provide optical beams to the array of beam sources 110. For example, the optical bench system 100, 300, 400, 500, 600, 700, 800 may be part of a system or assembly that includes a target apparatus 140 that defines, at least in part, an array of target locations 144. In various embodiments, the optical bench system 100, 300, 400, 500, 600, 700, 800 is configured to condition and/or control respective optical properties of an array of optical beams and provide the respective optical beams of the array of optical beams to respective target locations 146 of the array of target locations 144. An example of such a system that may include an optical bench system 100, 300, 400, 500, 600, 700, 800 is a QCCD-based quantum computing system 900, as illustrated by FIG. 9.

FIG. 9 provides a schematic diagram of an example quantum computing system 900 comprising an optical bench system 100, in accordance with an example embodiment. In various embodiments, the optical bench system 100 comprises an array of optical beam sources 110, an array of beam-customized optical components 120, and a relay component 130. The example quantum computing system 900 further includes a plurality of manipulation sources 64 (e.g., 64A, 64B, . . . , 64N). The plurality of manipulation sources 64 are configured to generate respective optical beams 66 (e.g., 66A, 66B, . . . , 66N) that are provided (e.g., via free space optics, waveguides, optical fibers, and/or the like) to the array of beam sources 110. The example quantum computing system 900 further includes a quantum object confinement apparatus 50 that is a target apparatus 140. For example, the quantum object confinement apparatus 50 defines, at least in part, an array of target locations 144. The optical bench system 100 provides an array of property-controlled optical beams 168 that have respective optical properties that have been controlled and/or conditioned (e.g., via the respective beam-customized optical components of the array of beam-customized optical components 120) to respective target locations 146 of the array of target locations 144. For example, a respective optical beam 166 (e.g., 166A, . . . , 166N) have respective optical properties that have been controlled and/or conditioned by a respective beam-customized optical component is provided such that the respective optical beam 166 is incident on a respective target location 146.

In various embodiments, the quantum computing system 900 comprises a computing entity 10 and a quantum computer 910. In various embodiments, the quantum computer 910 comprises a controller 30 and a quantum processor 915. In various embodiments, the quantum processor 915 comprises a cryogenic and/or vacuum chamber 40, quantum object confinement apparatus 50 disposed within the cryogenic and/or vacuum chamber 40, one or more manipulation sources 64, an optical bench system 100, and one or more electric signal generators 70 configured to provide voltage and/or electrical signals to the electrical components (e.g., electrodes) of the quantum object confinement apparatus 50 to cause the quantum object confinement apparatus to generate a confining potential and/or to electrical components of any active optical elements of the beam-customized optical components and/or relay component of the optical bench system 100. The quantum object confinement apparatus 50 acts as a target apparatus 140 and defines, at least in part, a plurality of target locations 146. In various embodiments the quantum processor 915 further includes one or more photodetectors configured for detecting optical signals generated by quantum objects confined at respective object locations, magnetic field generators configured to for generating a desired magnetic field and/or magnetic field gradient at respective object locations, calibration and/or feedback loop sensors, and/or the like.

In various embodiments, the cryogenic and/or vacuum chamber 40 is a temperature and/or pressure-controlled chamber. For example, the quantum computing system 900 may comprise vacuum and/or temperature control components that are operatively coupled to the cryogenic and/or vacuum chamber 40.

In various embodiments, the quantum computer 910 comprises one or more electric signal generators 70. For example, the electric signal generators 70 may comprise a plurality of voltage drivers and/or voltage sources and/or at least one radio frequency (RF) driver and/or voltage source. The electric signal generators 70 may be electrically coupled to the corresponding electrical components (e.g., electrodes) of the quantum object confinement apparatus 50, in an example embodiment. For example, the electric and/or electromagnetic field formed at least in part by applying the voltage and/or electrical signals generated by the electric signal generators 70 to the electrical components of the quantum object confinement apparatus 50 causes and/or forms the confinement region(s) of the confinement apparatus.

In various embodiments, a computing entity 10 is configured to allow a user to provide input to the quantum computer 910 (e.g., via a user interface of the computing entity 10) and receive, view, and/or the like output from the quantum computer 910. The computing entity 10 may be in communication with the controller 30 of the quantum computer 910 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control and/or be in electrical communication with the electric signal generators 70, cryogenic system and/or vacuum system controlling the temperature and/or pressure within the cryogenic and/or vacuum chamber 40, manipulation sources 64, photodetectors, calibration and/or feedback loop sensors, any active optical elements of the array of beam-customized optical components 120 and/or relay component 130, and/or other systems controlling various environmental conditions (e.g., temperature, pressure, magnetic field, and/or the like) within the cryogenic and/or vacuum chamber 40 and/or configured to manipulate and/or cause a controlled evolution of quantum states of one or more quantum objects confined by the quantum object confinement apparatus 50. For example, the controller 30 may cause a controlled evolution of quantum states of one or more quantum objects within the confinement apparatus to execute a quantum circuit and/or algorithm. For example, the controller 30 may cause a reading procedure to be performed, possibly as part of executing a quantum circuit and/or algorithm. In various embodiments, the quantum objects confined within the confinement apparatus are used as qubits of the quantum processor 915 and/or quantum computer 910.

### Technical Advantages

Conventional beam plates and/or machined optical bread boards that house optical elements configured to control optical properties of laser beams provided to target locations tend to be multiple square feet in area. As target apparatuses increase in size and the number of optical beams to be provided to the target locations of the target apparatus increases, the physical size required for such conventional beam plates and/or machined optical bread boards becomes very large. The size of such conventional beam plates and/or machined optical bread boards, in addition to taking up a significant amount of physical space, may introduce errors and/or noise into functions performed by systems including such conventional beam plates and/or machined optical bread boards. For example, a small misalignment of an optical element may result in optical properties of a resultant optical beam provided to a target location being different from expected, resulting in the introduction of errors and/or noise in the function being performed via the use of the resultant optical beam. Therefore, technical problems exist regarding how to provide an array of optical beams to respective target locations of a target apparatus.

Various embodiments provide technical solutions to these technical problems. In various embodiments, an optical bench system is provided that includes a plurality of beam-customized optical elements that are formed on a beam plate substrate or a series of beam plate substrates. In various embodiments, the plurality of beam-customized optical elements include metasurfaces, An example optical bench system further comprises a relay component configured to relay an array of optical beams to the array of target locations. In various embodiments, the beam plate substrates define a surface area that is at most five inches by five inches. Thus, rather than requiring multiple square feet of surface area as do conventional beam plates, a beam plate substrate of an example optical bench system has a surface area of less than one-fifth of a square foot, in various embodiments. Additionally, the forming of the beam-customized optical elements on the beam plate substrate(s) decreases the complexity of aligning individual optical elements of the array of beam paths. Thus, various embodiments provide technical improvements to the fields of beam delivery systems, systems that include beam delivery systems, QCCD-based quantum computing, and/or the like.

### Example Controller

In various embodiments, an optical bench system 100, 300, 400, 500, 600, 700, 800 is incorporated into a system (e.g., a quantum computing system 900) comprising a controller 30. In various embodiments, the controller 30 is configured to control various elements of the system (e.g., quantum processor 915). For example, the controller 30 may be configured to control the electric signal generators 70, a cryogenic system and/or vacuum system controlling the temperature and pressure within the cryogenic and/or vacuum chamber 40, manipulation sources 64, cooling system, any active optical elements of the array of beam-customized optical components 120 and/or relay component 130, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the quantum object confinement apparatus 50 (e.g., the target apparatus 140 with respect to the optical bench system 100). In various embodiments, the controller 30 may be configured to receive signals from one or more photodetectors, calibration and/or feedback loop sensors, and/or the like.

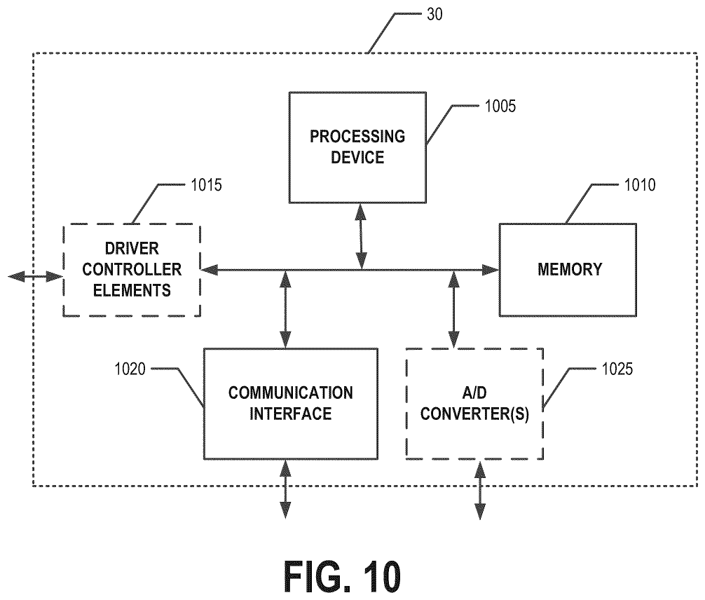

As shown in FIG. 10, in various embodiments, the controller 30 may comprise various controller elements including processing device 1005, memory 1010, driver controller elements 1015, a communication interface 1020, analog-digital (A/D) converter elements 1025, and/or the like. For example, the processing device 1005 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 1005 of the controller 30 comprises a clock and/or is in communication with a clock.

For example, the memory 1010 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FORAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1010 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 1010 (e.g., by a processing device 1005) causes the controller 30 to perform one or more steps, operations, processes, procedures and/or the like described herein for providing manipulation signals and/or optical beams that have respective optical properties that have been controlled and/or conditioned by the optical bench system 100, 300, 400, 500, 600, 700, 800 to respective target locations 146 defined at least in part by the quantum object confinement apparatus 50 and/or collecting, detecting, capturing, and/or measuring indications of emitted signals emitted by quantum objects located at corresponding object locations of the quantum object confinement apparatus 50. In various embodiments, the computer program code stored in the memory 1010 comprise quantum assembly (QASM) and/or quantum intermediate representation (QIR) code and/or machine code generated by compiling QASM and/QIR code.

In various embodiments, the driver controller elements 1015 may include one or more drivers and/or controller elements each configured to control one or more drivers. In various embodiments, the driver controller elements 1015 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 1005). In various embodiments, the driver controller elements 1015 may enable the controller 30 to operate electric signal generators 70, manipulation sources 64, cooling system, and/or the like. In various embodiments, the drivers may be laser drivers configured to operate one or manipulation sources 64 to generate manipulation signals; vacuum component drivers; cryogenic and/or vacuum system component drivers; cooling system drivers, and/or the like. In various embodiments, the controller 30 comprises means for communicating and/or receiving signals from one or more optical receiver components (e.g., photodetectors calibration and/or feedback loop sensors). For example, the controller 30 may comprise one or more analog-digital converter elements 1025 configured to receive signals from one or more optical receiver components (e.g., a photodetector of the optics collection system), calibration and/or feedback loop sensors, and/or the like.

In various embodiments, the controller 30 may comprise a communication interface 1020 for interfacing and/or communicating with a computing entity 10. For example, the controller 30 may comprise a communication interface 1020 for receiving executable instructions, command sets, and/or the like from the computing entity 10 and providing output received from the quantum computer 910 (e.g., from an optical collection system) and/or the result of a processing the output to the computing entity 10. In various embodiments, the computing entity 10 and the controller 30 may communicate via a direct wired and/or wireless connection and/or via one or more wired and/or wireless networks 20.

### Example Computing Entity

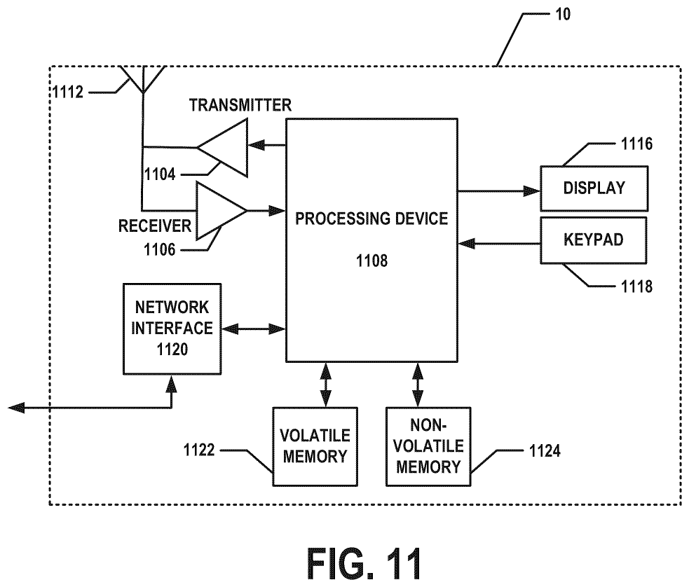

FIG. 11 provides an illustrative schematic representative of an example computing entity 10 that can be used in conjunction with embodiments of the present invention. In various embodiments, a computing entity 10 is configured to allow a user to provide input to the quantum computer 910 (e.g., via a user interface of the computing entity 10) and receive, display, analyze, and/or the like output from the quantum computer 910.

As shown in FIG. 11, a computing entity 10 can include an antenna 1112, a transmitter 1104 (e.g., radio), a receiver 1106 (e.g., radio), and a processing element 1108 that provides signals to and receives signals from the transmitter 1104 and receiver 1106, respectively. The signals provided to and received from the transmitter 1104 and the receiver 1106, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 may comprise a network interface 1120 for interfacing and/or communicating with the controller 30, for example. For example, the computing entity 10 may comprise a network interface 1120 for providing executable instructions, command sets, and/or the like for receipt by the controller 30 and/or receiving output and/or the result of a processing the output provided by the quantum computer 910. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 1116 and/or speaker/speaker driver coupled to a processing element 1108 and a touch screen, keyboard, mouse, and/or microphone coupled to a processing element 1108). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1118 (hard or soft), a touch display, voice/speech or motion interfaces, scanners, readers, or other input device. In embodiments including a keypad 1118, the keypad 1118 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1122 and/or non-volatile storage or memory 1124, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An optical bench system comprising:
an array of beam-customized optical components, wherein the array of beam-customized optical components comprises a plurality of beam-customized optical components; and
a relay component,
wherein:
each beam-customized optical component of the plurality of beam-customized optical components is configured to control optical properties of a respective optical beam of a plurality of optical beams to provide a plurality of property-controlled optical beams, and
the relay component is configured to relay the plurality of property-controlled optical beams to respective target locations of an array of target locations.

2. The optical bench system of claim 1, wherein each beam-customized optical component comprises a respective metasurface.

3. The optical bench system of claim 1, wherein each beam-customized optical component comprises at least one of a waveplate or a lens.

4. The optical bench system of claim 1, wherein the respective incident location is one of an object location or a target apparatus-integrated optical element.

5. The optical bench system of claim 1, further comprising a beam source array comprising a plurality of beam sources, wherein a respective beam source of the plurality of beam sources is configured to provide the respective optical beam to a respective beam-customized optical component.

6. The optical bench system of claim 5, wherein the beam source array is one of a one-dimensional array of beam sources or a two-dimensional array of beam sources.

7. The optical bench system of claim 5, wherein the array of target locations is one of a one-dimensional array of target locations or two-dimensional array of target locations.

8. The optical bench system of claim 5, wherein the respective beam-customized optical component is configured to correct any directing errors introduced by a respective beam source of the beam source array.

9. The optical bench system of claim 1, wherein the optical properties of the respective optical beam include a polarization of the respective optical beam.

10. The optical bench system of claim 1, wherein the optical properties of the respective optical beam include a wavelength, focusing, beam waist, phase, direction of propagation, beam profile, or intensity of the respective optical beam.

11. The optical bench system of claim 1, wherein a respective beam-customized optical component comprises an upstream surface and a downstream surface, the respective beam-customized optical component is configured to receive the respective optical beam incident on the upstream surface, control the optical properties of the optical beam, and provide a property-controlled optical beam via the downstream surface.

12. The optical bench system of claim 11, wherein the respective optical beam incident on the upstream surface defines an incident beam axis, the property-controlled optical beam provided via the downstream surface defines a first order beam axis, and the incident beam axis is not parallel to the first order beam axis.

13. The optical bench system of claim 12, wherein a difference in a direction defined by the incident beam axis and a direction defined by the first order beam axis is used to spatially filter the property-controlled optical beam provided to a respective target location of the array of target locations.

14. A quantum computing system comprising:
one or more manipulation sources;
an optical bench system; and
a quantum object confinement apparatus defining an array of target locations,
wherein the optical bench system comprises:
a beam source array comprising a plurality of beam sources,
an array of beam-customized optical components, wherein the array of beam-customized optical components comprises a plurality of beam-customized optical components; and
a relay component,
wherein a respective beam source of the plurality of beam sources is configured to provide a respective optical beam to a respective beam-customized optical component of the array of beam-customized optical components, the respective beam-customized optical component is configured to control optical properties of the respective optical beam to provide a respective property-controlled optical beam, and the relay component is configured to relay the respective property-controlled optical beam to a respective target location of the array of target locations, and
wherein a respective manipulation source of the one or more manipulation sources is configured to provide the respective optical beam to the respective beam source.

15. The quantum computing system of claim 14, wherein the respective beam-customized optical component comprises a respective metasurface.

16. The quantum computing system of claim 14, wherein the respective beam-customized optical component comprises at least one of a waveplate or a lens.

17. The quantum computing system of claim 14, wherein the respective incident location is one of an object location or a target apparatus-integrated optical element.

18. The quantum computing system of claim 14, wherein the respective beam-customized optical component is configured to correct any directing errors introduced by a respective beam source of the beam source array.

19. The quantum computing system of claim 14, wherein the optical properties of the respective optical beam include a polarization, wavelength, focusing, beam waist, phase, direction of propagation, beam profile, or intensity of the respective optical beam.

20. The quantum computing system of claim 14, wherein:
a respective beam-customized optical component comprises an upstream surface and a downstream surface,
the respective beam-customized optical component is configured to receive the respective optical beam incident on the upstream surface,
control the optical properties of the optical beam, and provide a property-controlled optical beam via the downstream surface,
the respective optical beam incident on the upstream surface defines an incident beam axis,
the property-controlled optical beam provided via the downstream surface defines a first order beam axis,
the incident beam axis is not parallel to the first order beam axis, and
a difference in a direction defined by the incident beam axis and a direction defined by the first order beam axis is used to spatially filter the property-controlled optical beam provided to the respective target location of the array of target locations.
